(19) United States
(12) Patent Application Publication
(10) Pub. No.: US 2007/0048478 A1
(43) Pub. Date: Mar. 1, 2007

(54) Core and release liner for adhesive film

(76) Inventor: Brett G. Webster, Walpole, MA (US)

Correspondence Address: WOLF GREENFIELD & SACKS, PC, FEDERAL RESERVE PLAZA, 600 ATLANTIC AVENUE, BOSTON, MA, 02210-2206, US

(21) Appl. No.: 11/210,145

(22) Filed: Aug. 23, 2005

(51) Int. Cl. B32B 33/00

(52) U.S. Cl. 428/40.1; 428/36.91

(57) ABSTRACT

A novel core and release liner for a pressure sensitive adhesive film are provided. In one embodiment, a cylindrical core about which an adhesive film is wound includes a compressible layer. In another embodiment, a release liner is provided for use with an adhesive film, that includes a plastic textured surface, such as one that has peaks and valleys. The peaks and valleys may form a matte surface.

### FIELD OF INVENTION

The present invention relates generally to pressure sensitive adhesive films, and more particularly to an improved construction of the core upon which the film is wound and an improved release liner construction, and related methods for preserving desirable qualities of the adhesive film.

### BACKGROUND OF INVENTION

Adhesive films are used in a variety of applications. For example, adhesive films are used in construction, insulation, and HVAC applications. There are also numerous types of industrial, medical, shielding, and glazing applications for adhesive films. Adhesive films may have adhesive on one or both sides. These films generally use pressure sensitive adhesives.

One application for a single-sided adhesive film is as a covering to protect the exterior surface of an object, such as an automobile. Automobiles are susceptible to chips, insect damage, environmental damage, and miscellaneous abrasions. A clear, protective adhesive film on parts of the automobile, such as the hood, doors, or bumpers, helps to prevent chips and other damage by acting as a barrier layer.

It is desired for proper appearance that such protective films be free of defects or markings that would impair the optical clarity of the film. For example, when an adhesive film is applied to a visible location, such as on an automobile surface, a uniform adhesive film, without any streaks, markings, dull spots, defects, or blemishes may be important. In applications where a transparent adhesive film layer is used, it is often desirable for the presence of the film to be undetectable. Therefore, preserving the optical clarity of an adhesive film may be beneficial in some applications.

Defects in an adhesive film may result when the adhesive film is wound about a core. Typically, the core is made of paper materials, such as cardboard. The core is usually a rigid structure having a substantially cylindrical shape. Due to limitations in the film manufacturing process, it is difficult to obtain a film with a substantially uniform thickness. Although the variation in thickness may be small, any variation may be compounded when the film is repeatedly wound about itself around a rigid core. These thickness variations may cause some portions of the film on the core to be under more pressure than others. These portions are called pressure points. Because the adhesive film is typically stored in its wound configuration, these pressure points may remain until the film is unrolled for use. This period of time could be very long, of the order of several months. These pressure points may cause defects in the adhesive film, such as thinning of the adhesive layer. This thinning could cause visible streaks in the film that extend across the width of the rolled film, or in a direction parallel to the axis of the core. Such defects may affect the visual appearance of the film. These and other defects may also alter the adhesive properties of the film.

Defects in an adhesive film may also result from manual handling of the film by the end user. In many applications, an adhesive film is handled by a user's fingers when applying the film to a desired surface. The adhesive portion of the film may retain fingerprints of the user and other blemishes. Once the adhesive film is secured to the desired surface, the marks may become noticeable. Because the marks are on the adhesive side which is trapped between the film and the surface, the noticeable marks remain visible for a long period of time. If the surface qualities of the film are critical to the application, it may be necessary to remove the film entirely and replace it with another film to remove the marks.

One known approach to minimizing some of the above-mentioned defects is to use a paper release liner where one side of the release liner has a matte surface finish. However, this type of release liner is inadequate for eliminating defects on the adhesive film. In particular, when such a paper release liner is removed from the adhesive layer, it leaves an undesirable “orange peel” surface on the adhesive layer. This defect is caused by the surface irregularities of a paper material. After applying the adhesive film to a surface, this “orange peel” pattern remains visible on the adhesive layer through the adhesive film. Even if the use of a paper release liner may prevent some defects, it creates additional defects, thereby making paper release liners undesirable for many applications.

### SUMMARY OF INVENTION

In one aspect, a combination of a core, a film, and a compressible layer is disclosed. In particular, the combination includes a substantially cylindrical core, a film comprising a pressure sensitive adhesive layer disposed on at least one side of the film, where the film is wound about the core, and a compressible layer associated with the core.

In another aspect of the invention, a method of assembling adhesive film is disclosed. The method includes the steps of providing a substantially rigid cylindrical core, and providing a compressible layer with the cylindrical core. The method further includes the steps of providing a film with a pressure sensitive adhesive layer disposed on at least one side of the film, and winding the film around the core.

In yet another aspect of the invention, a combination of a film and a release liner is disclosed. In particular, the combination includes a film with a pressure sensitive adhesive layer disposed on at least one side of the film, and a release liner having a first side and a second side. The first side of the release liner is adjacent the at least one side of the film, the release liner includes a plastic layer and the plastic layer has a surface featuring peaks and valleys on the first side of the release liner.

In yet another aspect of the present invention, a method of assembling adhesive film is disclosed. The method includes the steps of providing a film having a first side and a second side, and providing a release liner having a first side and a second side, where the release liner includes a plastic layer on the first side of the release liner, and the plastic layer has a surface featuring peaks and valleys. An adhesive layer is applied to the first side of the release liner, and the adhesive layer on the first side of the release liner is applied to the first side of the film.

In yet another aspect of the present invention, a release liner for use with a pressure sensitive adhesive film is disclosed. The release liner includes a base layer, having a first side and a second side, and a first plastic layer having a first side and a second side, where the first side of the first plastic layer is associated with the first side of the base layer, and the second side of the first plastic layer has a surface featuring peaks and valleys. A first coating layer is provided on the second side of the first plastic layer.

In yet one more aspect of the present invention, a method of manufacturing a release liner for use with a pressure sensitive adhesive film is disclosed. In particular, the method includes the steps of providing a base layer, having a first side and a second side, and coating a first plastic layer on the first side of the base layer, where the first plastic layer is provided with a surface featuring peaks and valleys. The method further comprises coating a second plastic layer on the second side of the base layer, and providing the second plastic layer with a surface featuring peaks and valleys. A first layer of silicone is coated on to the first plastic layer, and a second layer of silicone is coated on to the second plastic layer.

### BRIEF DESCRIPTION OF DRAWINGS

Various embodiments of the present invention will now be described, by way of example, with reference to the accompanying drawings, in which:

FIG. 1 is a schematic side view of one method of manufacturing adhesive film according to one embodiment of the present invention;

FIG. 2 is a partial side view of adhesive film wound around a prior art substantially incompressible core;

FIG. 3 is a perspective view of a roll of adhesive film according to another embodiment of the present invention;

FIG. 4 is a side view of a core for winding film according to another embodiment of the present invention;

FIG. 5 is a perspective view of a core for winding film according to another embodiment of the present invention;

FIG. 6 is a side view of adhesive film with a release liner according to yet another embodiment of the present invention;

FIG. 7 is a side view of a release liner according to another embodiment of the present invention;

FIG. 8 is a side view of a release liner prior to bonding with an adhesive film according to another embodiment of the present invention;

FIG. 9 is a side view of an adhesive film bonded to the release liner of FIG. 8; and

FIG. 10 is a side view of the adhesive film of FIG. 9 after removal of the release liner.

### DETAILED DESCRIPTION AND DISCUSSION OF INVENTION

In one aspect, the present invention relates to an adhesive film assembly that preserves desirable qualities of the adhesive film. As described in further detail below, some aspects of the present invention relate to an adhesive film wound about a cylindrical core, with a compressible layer associated with the core. The compressible layer may be wrapped around the core and disposed between the film and the core. Other aspects of the present invention relate to an adhesive film having a release liner that transfers desirable surface topographies of the release liner to the adhesive on the film. Still further aspects of the present invention are directed to a plastic release liner having at least one textured surface, such as a matte surface, that may include peaks and valleys.

Turning now to the drawings, it should be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one figure, and/or may also encompass embodiments combining components illustrated in multiple different drawings.

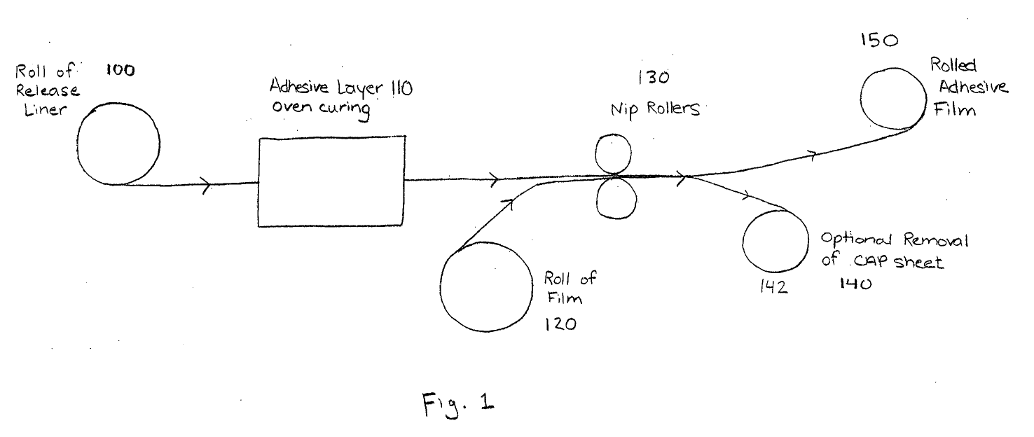

In FIG. 1, a schematic view of one method of manufacturing a pressure sensitive adhesive film is illustrated. Adhesive film typically includes a base film layer 120 and at least one pressure sensitive adhesive layer 110. To preserve the tackiness of the adhesive, a release liner 100 may be disposed adjacent the adhesive layer. An adhesive layer may be disposed on one or both sides of the base layer 120. It should be appreciated that the adhesive layer also may be applied only to selected portions of one side of the base layer. In some embodiments, the adhesive layer is applied to at least one entire surface of the base film layer 120.

As shown in FIG. 1, one process of manufacturing an adhesive film starts with unrolling a roll of release liner 100. An adhesive layer 110 is cast or applied to the unrolled release liner in a conventional manner. The coated release liner may travel through an oven to dry and cure the adhesive on the release liner. A roll of the base film 120 is unrolled and the base film 120 is positioned against the adhesive side of the release liner. The base film 120 and releaser liner 100 pass through nip rollers 130. Thereafter, the assembly of the release liner 100, adhesive layer 110, and base film layer 120 is wound about roller 150.

In one embodiment, the roll of the base film 120 may include both the base film 120 and a supportive cap sheet 140. If a cap sheet 140 is provided, once the base film 120 is nipped onto the adhesive layer 110, the cap sheet may be separated from the assembly and wound about roller 142.

It should be appreciated that FIG. 1 illustrates one embodiment of a film manufacturing process. Accordingly, the adhesive film may be manufactured differently in different applications. In one embodiment, the adhesive layer may cure without going through an oven. Also, if a cap sheet 140 is provided, the cap sheet 140 may be left on the film 120 during the manufacturing process and wound up with base film 120, adhesive layer 110, and release liner 100. In this event, cap sheet 140 is removed by the user when the adhesive film is applied to a surface. The adhesive film also may include adhesive layers on both sides of the base film layer. In this embodiment, a release liner may be provided on each adhesive side, or a single double-sided release liner is used. Further, it should be appreciated that in some embodiments, the adhesive layer may be applied to the base film layer 120 during the manufacturing process. The order in which the various films, layers, and/or coatings are bound together may be altered, as the present invention is not limited in this respect.

Various types of conventional pressure sensitive adhesives may be used to form the adhesive layer 110. For example, in one embodiment, an acrylic based adhesive is used as the pressure sensitive adhesive. In other embodiments, other types of adhesives, such as rubber or urethane based adhesives may be used to form an adhesive layer. If there is an adhesive layer on both sides of the base layer, the layers may have differential adhesive properties.

Various materials may be used to form the base film layer. As mentioned above, a cap sheet 140 may be used to form the base film layer 120. A cap sheet is typically used as a support surface when forming the base film layer. The cap sheet provides a support structure for the base layer if applied in liquid form. In one embodiment, the base film layer 120 is made from a urethane. In other embodiments, the base film layer may be formed of other materials, such as polyethylene or polyvinyl chloride (PVC), as the present invention is not limited in this respect.

Compressible Core

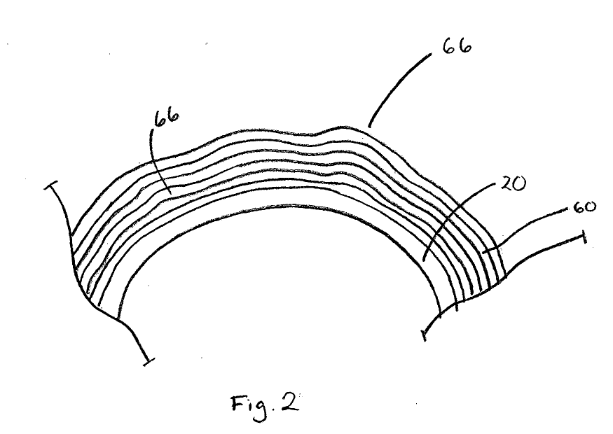

Referring now to FIGS. 2-5, one aspect of the present invention relates to a compressible core or compressible core component about which an adhesive film may be wound. In another aspect, the invention relates to a combination of a compressible core and a film wrapped about that core. As mentioned above, wrapping an adhesive film about a core may cause pressure points which may crush or pinch the adhesive film, and/or may flatten the adhesive layer causing it to thin out. This may cause defects in the adhesive film. However, Applicant has discovered that using a compressible core or a core with a compressible component, such as a layer, when winding adhesive film into a roll minimizes pressure points, and thus reduces the occurrence of defects in the adhesive film. In particular, a compressible layer may create a cushion to accommodate the build-up of pressure and thus reduce high pressure points across the film.

The adhesive film may be wound tightly about core 20. A tight wind typically minimizes the existence of air pockets between the layers of film. For the purposes of this invention, the terms “wind” or “wound” are intended to also encompass any form of winding, wrapping, or rolling of the adhesive film about or around the core 20. As the film is wound about core 20, areas of higher pressure may form due to variations in film thickness. As shown in FIG. 2, pressure points 66 may occur in the adhesive film 60 where due to excess thickness of the film in some areas, repeated layering of film creates thicker portions on the roll of film than other portions. Alternatively, repeated layering of thinner portions of the film may create depressions. Core 20 is substantially rigid and incompressible. Therefore, the core is not capable of providing any cushioning or pressure absorption. As a result, the layer of adhesive film 60 may be bumpy and uneven as shown in FIG. 2. For example, in one embodiment, the specified thickness for a particular adhesive film may be 6 mils. In one embodiment, the thickness of this film may vary anywhere between about 5 mils and about 6.2 mils. The thickness may vary across the length and width of the film. This thickness irregularity is commonly known as “gauge band”. Although this gauge band is relatively small, and may not even be detectable to the eye, the variation is compounded by repeatedly winding the film about the core. If the film is wound about the core 100 times, the increase in thickness could be 100 times the thickness deviation or “gauge band” of a single layer, which may make the thickness increase no longer insubstantial. It should be appreciated, that in some embodiments, the thickness variations of an adhesive film are not uniform about the diameter of the core. Accordingly, every time the film is wound about a core the result may not necessarily be an increase in thickness. Nevertheless, experiments have shown that repeatedly winding a film about a core may cause areas in the coiled adhesive film to either built up and/or form depressions due to the collective variations at one point or in one area on the roll of the film, due to the tension on the film. Because this eliminates the uniform configuration of the film, these built up and/or depressed areas may create pressure points which may affect desired optical and other qualities of the adhesive film. For example, the pressure points may result in a visible thinning out of the adhesive layer and/or the film layer.

The compressible layer 40 of the present invention, as shown in FIG. 3, reduces these pressure points by accommodating the increased pressure at those pressure points. In one embodiment, the compressible layer may act like a shock absorbing system. Some of the pressure caused by tension on the film is absorbed by the compressible layer 40 as the film is wound. The compressible layer may actually compress at such pressure points. Accordingly, the use of a compressible layer 40 may preserve certain qualities of the adhesive film. In particular, the compressible layer may preserve the optical qualities of the film, by reducing the number of defects in the film.

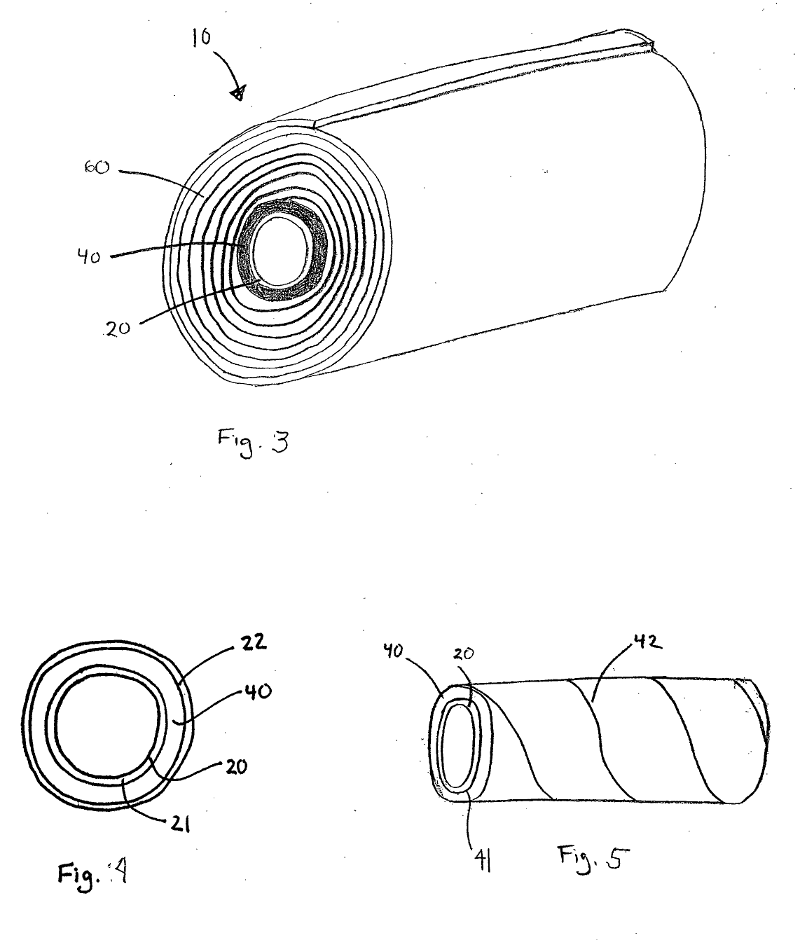

The compressible layer 40 may be arranged with respect to core 20 in a variety of different ways. In one embodiment, the entire core 20 may be compressible and layer 40 may comprise all of core 20. In another embodiment, as shown in FIG. 3, the compressible layer 40 is adjacent the outer surface of the substantially incompressible, cylindrical core 20 and is disposed between core 20 and rolled film 60. The compressible layer 40 may form a sleeve slidably received over the core. In other embodiments, the compressible layer 40 is wound around the core 20. An adhesive layer 41 may be used to secure the compressible layer 40 to the core, and/or the compressible layer 40 may maintain its position about the core by pressure fit. As shown in FIG. 5, in one embodiment, the compressible layer 40 is spirally wound about the core 20. In this embodiment, the edges 42 of compressible layer 40 are aligned edge-to-edge in a non-overlapping and spiral arrangement. Alternatively, the compressible layer 40 may be wound about the core in a non-spiral configuration. In yet another embodiment, the compressible layer 40 may be formed integrally with portions of the core, or the compressible layer 40 may be embedded into portions of the core 20. As shown in FIG. 4, in yet another embodiment, compressible layer 40 is disposed between layers 21 and 22 of core material and spaced from film 60 by layer 22. In this embodiment, compressible layer 40 typically is spaced from film 60 a substantially small distance (i.e. the thickness of layer 22 is small) so that pressure is still absorbed through the intervening layers 22 of the core material.

The compressible layer 40 may be made from a variety of different materials as the present invention is not limited in this respect. In one embodiment, the compressible layer 40 is formed from a foam material. The foam material may be either an open cell or closed cell foam. In some embodiments, the compressible layer 40 may be made of polyethylene, polyurethane, or polyvinyl chloride foam. The compressible layer 40 may also be made from various soft rubbers, rubber foams, cloths, flocked material, woven or non-woven materials, or knitted material, as the present invention is not limited in this respect. In one embodiment, the thickness of the compressible layer 40 ranges between about 1/32″ to about ¼″, and the density of the compressible layer ranges between about ½ lb/ft³ to about 30 lbs/ft³. In one particular embodiment, the compressible layer 40 is a closed cell polyethylene foam with a thickness of about 1/16″ and a density of about 4 lbs/ft³. However, it should be appreciated that in other embodiments, the thickness and density of the compressible layer 40 may be outside of these ranges.

According to one embodiment of the present invention, the compressible layer 40 is designed to meet certain compression deflection tests according to an ASTM standard. In particular, in one embodiment, the compressible layer 40 is designed to meet certain standards under ASTM D3575-00, which is a standard directed to testing methods for flexible cellular materials made from olefin polymers. In one embodiment, a pressure between about 0.5 psi and about 30 psi is required to compress the total thickness of the compressible layer 40 by 25%, as measured in accordance with the testing procedure for the 25% defection test under ASTM D3575-00. In another embodiment, a pressure between about 5 psi and about 20 psi is required to compress the total thickness of the compressible layer 40 by 25%, as measured in accordance with the testing procedure for the 25% defection test under ASTM D3575-00. However, it should be appreciated that some embodiments of the present invention may not be limited to particular values according to ASTM D3575-00.

The core 20 may also be made from a variety of materials. As mentioned above, cores are typically manufactured from paper, and are often cardboard. However, it should be appreciated that in other embodiments, the core may be made from other materials, such as plastic, metal, or fiberboard, as the present invention is not limited in this respect. In one particular embodiment, the thickness of the core is between about ⅛″ and about ¼″. However, in other embodiments, the core thickness may be about 1/100″. Cores may be manufactured into long cylindrical pieces and cut to the desired length. In one embodiment, a core is manufactured in 56″ segments. In one embodiment, the length of the core ranges from about ½″ to about 48″, however, in other embodiments, the core length may be greater or smaller than this range.

Release Liner

According to another aspect of the present invention, a novel release liner is disclosed. The release liner may assist in preserving optical qualities of an adhesive film. In one embodiment, the release liner includes at least one side having a textured surface which could include peaks and valleys. These peaks and valleys form a topographic relief, and may form a pattern.

In one embodiment, the textured surface is a matte finish. A matte finish may be described as a surface having a dull or roughened finish, which may create a surface topography which could have small peaks and valleys. In some embodiments, the peaks and valleys may be formed into a particular geometric pattern, such as a square pattern, circle pattern, linear plaid pattern, etc. In other embodiments, the peaks may form elongated ridges. It should be appreciated that the peaks and valleys may have many different configurations and may be formed by a variety of methods, as the present invention is not limited in these respects.

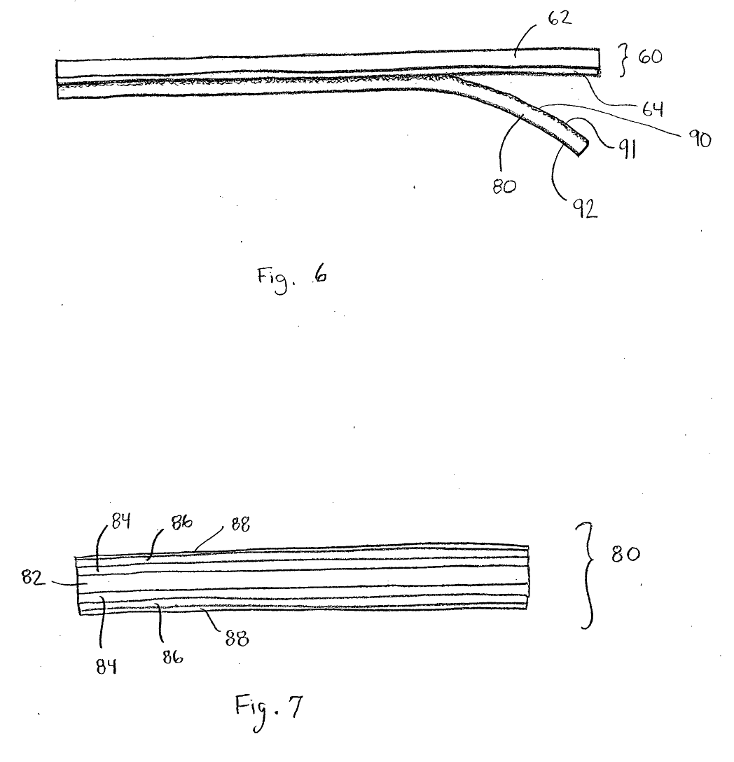

Turning to FIG. 6, a release liner 80 is shown in combination with an adhesive film 60. The adhesive film 60 includes a base film layer 62 and a pressure sensitive adhesive layer 64. In the embodiment shown in FIG. 6, the first side 90 of the release liner 80 faces the adhesive layer 64 and includes a textured surface 91. As described in more detail below, in other embodiments, the second side 92 of the release liner also may include a textured surface.

When a release liner featuring a textured surface is adjacent the adhesive layer 64 of the adhesive film 60, the adhesive layer 64 may form a corresponding texture. This transfer of surface texture is illustrated in FIGS. 8-10. As shown in FIG. 8, one side of the release liner 80 features a texture having peaks 94 and valleys 96. Once the adhesive film 60 is formed on the release liner 80 or the adhesive layer 64 is coated on release liner 80, an outer surface of the adhesive layer 64 conforms to the outer surface of the release liner 80, as shown in FIG. 9. In particular, peaks 94 in the release liner 80 form valleys on the outer surface of the adhesive layer 64, and valleys 96 on the release liner 80 form peaks on the outer surface of the adhesive layer 64. As mentioned above, the base film 62 may then be applied to the adhesive layer 64. When the release liner 80 is removed from the adhesive film 60, the peaks 94 and valleys 96 formed onto the outer surface of the adhesive layer 64 remain, as shown in FIG. 10. Once the peaks 94 and valleys 96 are formed onto the adhesive layer 64, the adhesive film 60 may have a hazy or dull appearance.

The presence of the surface with peaks 94 and valleys 96 on the adhesive layer 64 of adhesive film 60 may provide several benefits. First, in one embodiment, the peaks and valleys may provide a microporous surface that allows liquids and gases to be pressed out of the film during the application process. Secondly, in one embodiment, the peaks and valleys provides a topography that reduces the contact area of the adhesive layer during handling of the adhesive film. Third, in one embodiment, the peaks and valleys on the adhesive layer 64 may make the adhesive more pliable. Each of these benefits is described in more detail below.

First, the peak and valley structure on the adhesive layer may provide a microporous surface. In one embodiment, this structure creates micro-channels within the adhesive that permit liquids and gases to be released from the adhesive film as the film is applied to a desired surface. For example, air bubbles or water pockets may be susceptible to form between the adhesive film and the desired surface. When an adhesive film is applied to a desired surface, it is common for a uniform pressure to be applied along the length and width of the film, such as with a squeegee, to adhere the film to the surface. When this pressure is exerted during the application process, the micro-channels create a path for any unwanted liquid or gas to escape out from under the film. This is beneficial because liquid or gas trapped by the film may create visible defects in the adhesive film, which is undesirable in many applications.

Second, the peak and valley structure on the adhesive layer may provide a topography that reduces the contact area of the adhesive layer during handling of the adhesive film. As discussed above, in many applications, the adhesive film must be touched with one's hands during the application process. This handling leads to marks, such as fingerprints, on the adhesive layer of the film. However, the peak and valley structure reduces the contact area because when one handles the adhesive layer, his or her fingerprint may be limited to only the peaks. Because the valley portions are protected by the peaks, a smaller area of the adhesive layer is contacted when the film is handled. This minimizes the visible defects associated with handling of the film. Further, during the application process, when pressure is exerted on the film, such as with a squeegee to adhere the film to the desired surface, the peak and valley structure of the adhesive layer may be flattened. Not only does this flattening reduce the hazy or dull appearance that may be associated with the peaks and valleys, but it also may reduce any marks, such as fingerprints, which remain on the peaks from handling. The hazy, or dull appearance of the film is replaced with a clear, smooth appearance.

Third, the peaks and valleys on the adhesive layer 64 may make the adhesive layer more pliable. When peaks and valleys are formed into the adhesive layer, the thickness of the adhesive layer becomes less uniform. Areas where peaks form typically have a greater thickness, and areas where valleys form typically have a smaller thickness. Because the thinner portions will bend more easily than the thicker portions, this configuration may make the structure more malleable or pliable. In one embodiment, the peak and valley configuration of the adhesive layer lowers the modulus of elasticity of the material. This may be beneficial because it may enhance the conformability of the adhesive film to an irregularly shaped surface. The increased pliability of the adhesive layer may also be beneficial because it may increase the peel strength of the adhesive layer.

As mentioned above, in one embodiment, the second side 92 of the release liner 80 (the side opposite the adhesive layer 64 in FIG. 6) may include a surface featuring peaks and valleys. This may be beneficial to reduce liquid or gas entrapment between the layers of the adhesive film as the film is wound around a core. When liquid or air is trapped between the layers of adhesive film, it may create undesirable bubbles in the film, which are sometimes called “fish eyes”. The presence of the micro-channels created by the peak and valley structure may form a path for the unwanted liquid or gas to escape to an outer edge of the film, keeping the layers smoother. The peak and valley structure on the second side 92 of the release liner 80 may be formed in any of the ways in which the peaks and valleys may be formed onto the first side 90.

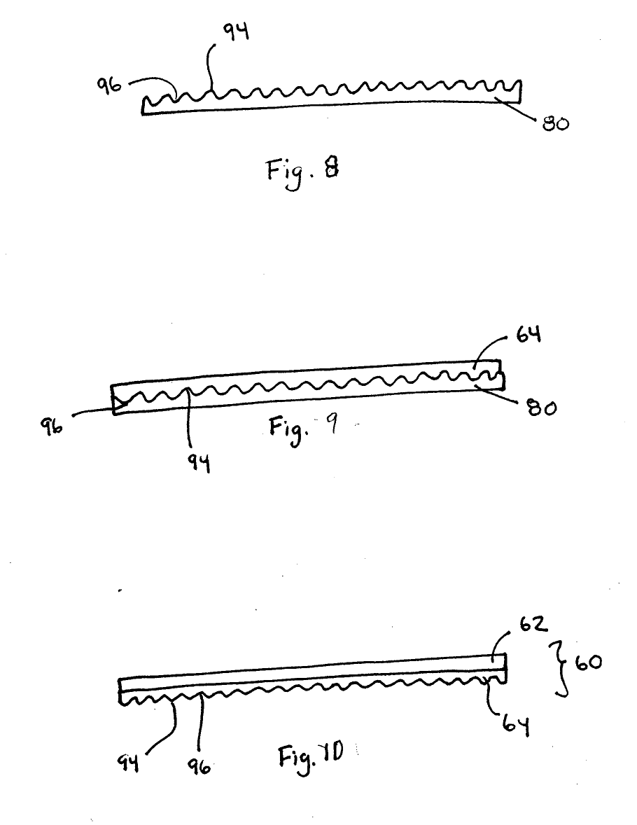

In one embodiment, the release liner 80 is formed from a plastic material. In some embodiments, as illustrated in FIG. 7, the release liner includes a plurality of layers sandwiched together. For example, this particular embodiment includes a base layer 82. In one embodiment, the base layer may be made of plastic, such as polyethylene terephthalate (PET), or polyester, for example, while in other embodiments, the base layer 82 may be made from other materials, such as paper. On each side of the base layer 82, a first and second layer 84 of an adhesive may be provided. In one embodiment, these layers may include an adhesive, such as a polyurethane adhesive. On top of each adhesive layer 84 a further plastic layer 86 may be provided. In one embodiment, the plastic layer is high density polyethylene layer (HDPE). In other embodiments, a material such as polyester may be used. As shown in FIG. 7, covering each layer 86 is a coating 88. The coating 88 is provided with low adhesion and high release characteristics, so that the release liner 80 is easily removable. In one embodiment, the coating 88 includes silicone, but in other embodiments, other release coatings may be used.

The base layer 82 of the release liner 80 may form a majority of the thickness of the release liner. For example, in one embodiment, the thickness of the release liner 80 is about 3.25 mils, and the base layer 82 has a thickness of about 3 mils. In other embodiments, the thickness of the release liner 80 may be less, such as about 2 mils.

In one embodiment, the outermost layer of the release liner 80 may include the peak and valley structure. However, in other embodiments, the peaks and valleys may be formed onto an intermediate layer of the release liner. For example, the peak and valley structure may be formed in the plastic layer 86, because the coating layer 88 is so thin and it takes on the textured pattern of layer 86. In one embodiment of the method of manufacture, each plastic layer 86 may be extrusion coated onto the base layer 82 of the release liner. As mentioned above, there may be intermediate layers between the base layer 82 and layer 86. Before the plastic layer 86 solidifies, the peak and valley structure may be formed into layer 86. Additional thin layers, such as a silicone coating 88, may be applied over the peaks and valleys. In one embodiment, the thickness of the coating 88 is only about 15 angstroms.

One method of applying the peaks and valleys to the release liner is by using a roller, where the outer surface of the roller is ground to the desired contour of peaks and valleys. In this embodiment, the textured outer surface of a roller may be transferred to portions of the release liner to provide a similar texture. For example, in one embodiment, once plastic layer 86 is extrusion coated onto the base layer 82 of the release liner, it is wound around a chill roller to solidify the plastic material. The outer surface of the chill roller may include a textured surface, such that as layer 86 solidifies, the peaks and valleys from the outer surface of the chill roller are formed into and solidify with the plastic layer 86. In one embodiment, the rough outer surface of the chill roller may provide a matte surface on layer 86. Thereafter, a release coating 88, such as a silicone coating, may be applied to the textured outer surface of the plastic layer 86 such that the coating 88 conforms to the topography of the textured surface.

It should be appreciated that the above represents only one embodiment of constructing a release liner of the present invention. In other embodiments, other types of plastic materials may be provided to form the release liner in either a single layer or multiple layer construction, as the present invention is not limited in this respect.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1-20. (canceled)

21. In combination:
a film with a pressure sensitive adhesive layer disposed on at least one side of said film; and
a release liner having a first side and a second side, wherein the first side is adjacent the at least one side of said film, wherein the first side of said release liner includes a plastic layer, and wherein said plastic layer has a surface comprising peaks and valleys.

22. The combination of claim 21, wherein the second side of said release liner has a surface comprising peaks and valleys.

23. The combination of claim 21, wherein the surface comprising peaks and valleys is a matte surface.

24. The combination of claim 21, wherein the surface comprising peaks and valleys includes ridges and valleys.

25. The combination of claim 22, wherein the second side of said release liner comprising peaks and valleys is a matte surface.

26. The combination of claim 23, wherein said release liner includes a base layer, wherein said base layer comprises a paper or plastic material.

27. The combination of claim 21, wherein said plastic layer of said release liner comprises high density polyethylene, and wherein the high density polyethylene has a surface comprising peaks and valleys.

28. The combination of claim 21, further comprising a substantially cylindrical core, wherein said film and said release liner are wound together about said core.

29. (canceled)

30. (canceled)

31. The combination of claim 21, wherein said film is a plastic film.

32. The combination of claim 21, wherein said film is a urethane film.

33. The combination of claim 21, wherein said pressure sensitive adhesive layer comprises an acrylic material.

34. A method of assembling adhesive film, comprising:
providing a film having a first side and a second side;
providing a release liner having a first side and a second side, wherein said release liner comprises a plastic layer on the first side of said release liner, wherein the plastic layer has a surface comprising peaks and valleys;
applying an adhesive layer to the first side of said release liner; and
applying said adhesive layer on said release liner to the first side of said film.

35. The method of claim 34, further comprising:
providing a cap sheet on the second side of said film; and
removing said cap sheet from said film after said adhesive layer is applied to the first side of said film.

36. A release liner for use with a pressure sensitive adhesive film, comprising:
a base layer, having a first side and a second side;
a first plastic layer, having a first side and a second side, wherein the first side of said first plastic layer is associated with the first side of said base layer, wherein the second side of said first plastic layer has a surface comprising peaks and valleys; and
a first coating layer provided on the second side of said first plastic layer.

37. The release liner of claim 36, wherein the base layer comprises a plastic material.

38. The release liner of claim 37, wherein the base layer comprises polyethylene terephthalate.

39. The release liner of claim 36, wherein the base layer comprises a paper material.

40. The release liner of claim 36, wherein said first plastic layer comprises high density polyethylene.

41. The release liner of claim 36, wherein the surface comprising peaks and valleys is a matte surface.

42. The release liner of claim 36, wherein the surface comprising peaks and valleys includes ridges and valleys.

43. The release liner of claim 36, wherein said first coating layer comprises silicone.

44. The release liner of claim 36, further comprising a first adhesive layer disposed between the first side of said base layer and the first side of said first plastic layer.

45. The release liner of claim 44, wherein said first adhesive layer comprises a polyurethane adhesive.

46. The release liner of claim 36, further comprising a second plastic layer, having a first side and a second side, wherein the first side of said second plastic layer is associated with the second side of said base layer, and wherein the second side of said second plastic layer has a surface comprising peaks and valleys; and
a second coating layer provided on the second side of said second plastic layer.

47. The release liner of claim 46, wherein said second plastic layer comprises high density polyethylene.

48. The release liner of claim 46, wherein said second coating layer comprises silicone.

49. The release liner of claim 46, further comprising a second adhesive layer disposed between the second side of said base layer and the first side of said second plastic layer.

50. The release liner of claim 49, wherein said second adhesive layer comprises a polyurethane adhesive.

51. A method of manufacturing a release liner for use with a pressure sensitive adhesive film, comprising:
providing a base layer, having a first side and a second side;
coating a first plastic layer on the first side of said base layer;
providing said first plastic layer with a surface comprising peaks and valleys;
coating a second plastic layer on the second side of said base layer;
providing said second plastic layer with a surface comprising peaks and valleys;
coating a first layer of silicone on said first plastic layer; and
coating a second layer of silicone on said second plastic layer.
